(19) United States
(12) Patent Application Publication
(10) Pub. No.: US 2007/0030836 A1
(43) Pub. Date: Feb. 8, 2007

(54) Apparatus and method for transmitting/receiving signal using differentiated multilevel modulation/demodulation in a wireless mobile communication system

(75) Inventors: Kyung-Joo Suh, Suwon-si (KR); Ki-Young Han, Yongin-si (KR); Dong-Ho Cho, Seoul (KR); Ki-Ho Lee, Daejeon (KR); Soo-Yong Jeon, Daejeon (KR); Chi-Sung Bae, Andong-si (KR); Jong-Wuk Son, Uljin-gun (KR); Soon-Young Yoon, Seoul (KR); Jae-Hee Cho, Seoul (KR); Young-Hoon Kwon, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/497,584

(22) Filed: Aug. 2, 2006

(30) Foreign Application Priority Data
Aug. 2, 2005 (KR) 2005-70724

(51) Int. Cl. H04Q 7/24

(52) U.S. Cl. 370/338; 370/394

(57) ABSTRACT

A method is provided for transmitting a packet data unit (PDU) by a transmitter in a wireless mobile communication system. The method includes determining at least one desired transmission PDU, determining a modulation scheme corresponding to the number of PDUs, and transmitting a first indicator value indicating the number of PDUs and the modulation scheme, transmitting the PDUs, receiving a second indicator value indicating a reception state of the PDUs, from a receiver that receives the PDUs, determining a new PDU or a retransmission PDU according to the second indicator value, and determining a modulation scheme corresponding to the number of the determined PDUs, and transmitting a third indicator value indicating the number of PDUs and the modulation scheme, and the corresponding PDUs.

### PRIORITY

This application claims the benefit under 35 U.S.C. §119(a) of an application entitled “Apparatus and Method for Transmitting/Receiving Signal Using Differentiated Multilevel Modulation/Demodulation in a Wireless Mobile Communication System” filed in the Korean Intellectual Property Office on Aug. 2, 2005 and assigned Serial No. 2005-70724, the contents of which are incorporated herein by reference.

### BACKGROUND OF THE INVENTION

1. Field of the Invention

The present invention relates generally to an apparatus and method for transmitting/receiving signals in a wireless mobile communication system, and in particular, to an apparatus and method for transmitting/receiving signals using differentiated multilevel modulation/demodulation.

2. Description of the Related Art

In the 4^{th} generation (4G) communication system, active research is being conducted to provide services having various Qualities-of-Service (QoSs) supporting a high data rate to users. Therefore, research into the 4G communication system is now being conducted to develop a new communication system for guaranteeing mobility and QoS for a wireless Local Area Network (LAN) system and a wireless Metropolitan Area Network (MAN) system, both supporting a higher data rate, so as to support high-speed data service.

One of various schemes for supporting high-speed data service is an Adaptive Modulation and Coding (AMC) scheme, which is for adaptively determining a modulation and coding scheme according to channel state between a cell, i.e. a base station (BS) and a mobile station (MS), thereby improving the entire cell utilization. The AMC scheme has a plurality of modulation and coding schemes, with which it modulates and encodes a channel signal.

Commonly, each combination of the modulation and coding schemes is called a Modulation and Coding Scheme (MCS), and a plurality of MCSs of level 1 to level N can be defined according to the number of the MCSs. That is, the AMC scheme adaptively determines a level of the MCS according to channel state between an MS and a BS, thereby improving the entire system efficiency. Therefore, the BS should previously recognize Channel Quality Information (CQI) of each MS. To this end, the MS measures a CQI and reports the measured CQI to the BS, and the BS can determine an MCS level of the corresponding MS considering the reported CQI.

However, when several MSs simultaneously feed CQIs back to the BS, high overhead may occur in the system, reducing the system performance. In addition, when channel variation is considerable, CQI feedback of the MSs occurs very frequently. Further, the CQI being fed back over a poor channel may have a high error rate, and if the BS allocates an inappropriate MCS level depending on the received defective CQI, it may cause a loss of wireless resources and a reduction in system performance.

### SUMMARY OF THE INVENTION

It is, therefore, an object of the present invention to provide an apparatus and method for transmitting data robust against errors in a wireless mobile communication system.

It is another object of the present invention to provide an apparatus and method for transmitting data at different robustness against errors using differentiated multilevel modulation in a wireless mobile communication system.

It is further another object of the present invention to provide an apparatus and method in which a transmitter transmits/receives data depending on a reported indicator value for the data received from a receiver to thereby minimize a signaling load in a wireless mobile communication system.

According to the present invention, there is provided a method for transmitting a signal in a communication system that encodes desired transmission packet data units (PDUs), modulates the coded bits and transmits modulation symbols. The method includes dispersedly mapping the coded bits to each of a plurality of modulation symbols determined according to a modulation scheme, and transmitting the modulation symbols.

According to the present invention, there is provided a method for transmitting a packet data unit (PDU) by a transmitter in a wireless mobile communication system. The method includes determining at least one desired transmission PDU, determining a modulation scheme corresponding to the number of PDUs, and transmitting a first indicator value indicating the number of PDUs and the modulation scheme, transmitting the PDUs, receiving a second indicator value indicating a reception state of the PDUs, from a receiver that receives the PDUs, determining a new PDU or a retransmission PDU according to the second indicator value, and determining a modulation scheme corresponding to the number of the determined PDUs, and transmitting a third indicator value indicating the number of PDUs and the modulation scheme, and the corresponding PDUs.

According to the present invention, there is provided a method for receiving a packet data unit (PDU) by a receiver in a wireless mobile communication system. The method includes receiving from a transmitter a first indicator value indicating the number of PDUs and a modulation scheme, receiving at least one PDU, and performing error check on the received PDU, and transmitting to the transmitter a second indicator value indicating normal/abnormal receipt of the PDU.

According to the present invention, there is provided an apparatus for transmitting a signal in a wireless mobile communication system including an encoder for encoding desired transmission packet data units (PDUs) and outputting the coded bits. The apparatus includes a differentiated multilevel modulator for dispersedly mapping the coded bits to each of a plurality of modulation symbols determined according to a modulation scheme, and transmitting the modulation symbols.

According to the present invention, there is provided an apparatus for receiving a signal in a wireless mobile communication system including a decoder for performing decoding on input coded bits. The apparatus includes a differentiated multilevel demodulator for receiving modulation symbols, demodulating the modulation symbols using a demodulation scheme corresponding to a modulation scheme, and outputting the coded bits, wherein the coded bits are dispersedly mapped to each of a number of modulation symbols determined according to the modulation scheme

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal constellation for a conventional 16-ary Quadrature Amplitude Modulation (16QAM)-based signal modulation;

FIG. 2 is a diagram illustrating a signal constellation for a conventional 64QAM-based signal modulation;

FIG. 3 is a diagram illustrating a symbol mapping process for 64QAM-modualted PDUs in a wireless mobile communication system according to a first embodiment of the present invention;

FIG. 4 is a diagram illustrating a symbol mapping process for 256QAM-modualted PDUs in a wireless mobile communication system according to the first embodiment of the present invention;

FIG. 5 is a block diagram illustrating a structure of a transmitter in a wireless mobile communication system according to the first embodiment of the present invention;

FIG. 6 is a block diagram illustrating a structure of a receiver in a wireless mobile communication system according to the first embodiment of the present invention;

FIG. 7 is a signaling diagram illustrating a signal flow for PDU transmission/reception in a wireless mobile communication system according to a second embodiment of the present invention;

FIG. 8 is a block diagram illustrating a structure of a downlink transceiver in an OFDMA wireless mobile communication system according to the second embodiment of the present invention;

FIG. 9 is a block diagram illustrating a structure of an uplink transceiver in an OFDMA wireless mobile communication system according to the second embodiment of the present invention;

FIG. 10 is a flowchart illustrating a signal transmission process of a BS transmitter in a wireless mobile communication system according to the second embodiment of the present invention;

FIG. 11 is a flowchart illustrating a signal reception process of an MS receiver in a wireless mobile communication system according to the second embodiment of the present invention; and

FIG. 12 is a diagram illustrating a signal transmission/reception process between a BS and an MS in a wireless mobile communication system according to the second embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

A first embodiment of the present invention discloses an apparatus and method in which a transmitter in a wireless mobile communication system applies differentiated multilevel modulation to a plurality of data units, i.e. a plurality of Packet Data Units (PDUs), to transmit each PDU at different robustness against errors (hereinafter error robustness) of the corresponding PDU, and a receiver receives the PDUs modulated by the differentiated multilevel modulation and demodulates the received PDUs using a demodulation scheme corresponding to the modulation scheme.

A second embodiment of the present invention proposes an apparatus and method in which a transmitter in a wireless mobile communication system transmits PDUs using differentiated multilevel modulation, and a receiver recognizes normally/abnormally received PDUs, and notifies an appropriate indicator value to the transmitter, to thereby receive or re-receive the PDUs with minimum signaling load.

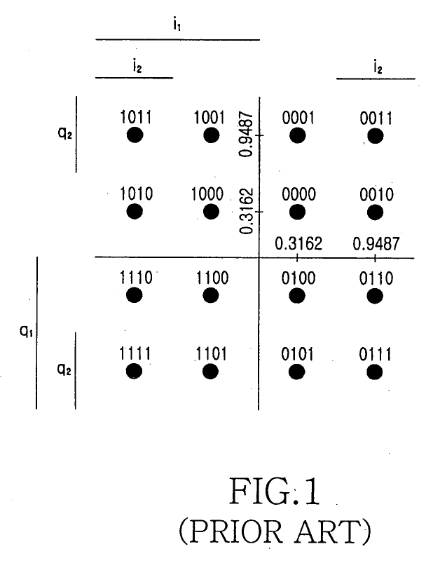

FIG. 1 is a diagram illustrating a signal constellation for a conventional 16-ary Quadrature Amplitude Modulation (16QAM)-based signal modulation.

Referring to FIG. 1, a 16QAM-modulated symbol is composed of 4 bits [i₁ q₁ i₂ q₂], and a reliability pattern of the symbol can be expressed as [H, H, L, L]. In the reliability pattern of the symbol, H indicates a bit position to which a high-reliability coded bit is mapped, and L indicates a bit position to which a low-reliability coded bit is mapped. That is, in the 16QAM, the first two bits have a higher reliability and the last two bits have a lower reliability. The high-reliability bits H serve to define quadrants on the constellation, and the low-reliability bits L serve to redefine each of the quadrants on the constellation.

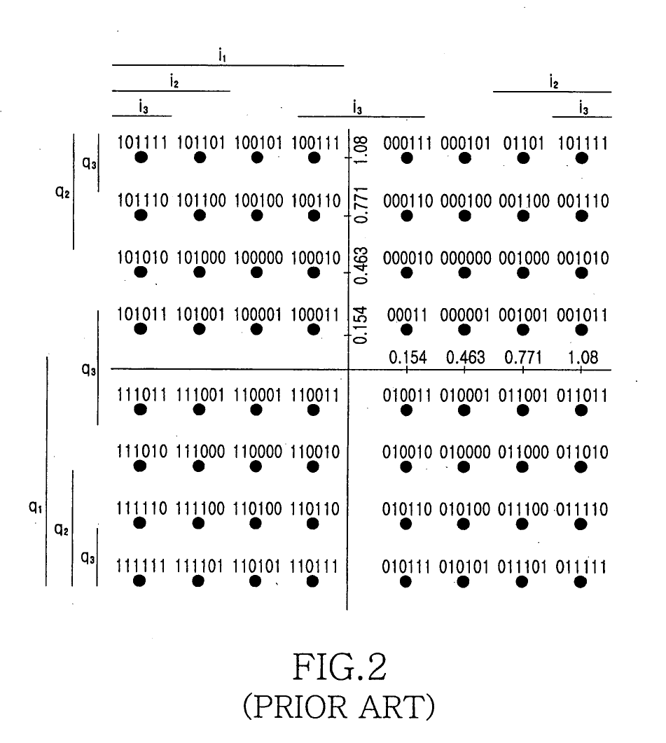

FIG. 2 is a diagram illustrating a signal constellation for a conventional 64QAM-based signal modulation.

Referring to FIG. 2, a 64QAM-modulated symbol is composed of 6 bits [i₁ q₁ i₂ q₂ i₃ q₃], and a reliability pattern of the symbol can be expressed as [H, H, M, M, L, L], where M indicates a bit position to which a medium-reliability bit is mapped.

A description will now be made of a method for constructing a symbol using differentiated multilevel modulation according to the present invention.

For example, in a fast-varying channel environment, it is difficult for a BS to determine an accurate Adaptive Modulation and Coding (AMC) scheme for an MS. Therefore, the BS preferably modulates a plurality of PDUs at various levels to transmit the PDUs that a receiver can successfully receive. That is, the receiver, if it has a good channel state, can successfully receive all the PDUs transmitted by the BS. Even though the receiver has a poor channel state, it can receive the PDUs to which the multilevel modulation differentiated to be robust against errors is applied.

Therefore, in order to construct the symbols having robustness against a multilevel error, the present invention maps some bits of each PDU to the bit positions having the highest robustness against errors in a corresponding symbol, and maps some other bits to the bit positions having the next highest robustness against errors in the symbol. While one modulation symbol is fully used for one PDU in the conventional technology, one modulation symbol is used for a plurality of PDUs in the present invention. That is, to transmit one PDU, the present invention maps the PDU to the bit positions having similar error robustness in a plurality of symbols.

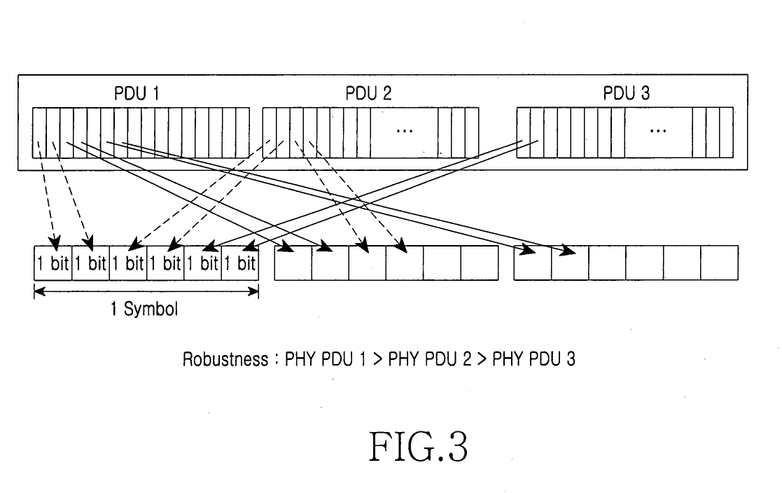

FIG. 3 is a diagram illustrating a symbol mapping process for 64QAM-modualted PDUs in a wireless mobile communication system according to a first embodiment of the present invention.

Referring to FIG. 3, each PDU is assumed to be composed of 16 bits, and the 16 bits include Cyclic Redundancy Checking (CRC check) bits. The use of the 64QAM can transmit modulation symbols associated with three PDUs, and one modulation symbol is composed of 6 bits. Therefore, a total of 8 modulation symbols are needed to transmit three PDUs.

As described with reference to FIG. 2, a 64QAM-modualted symbol has higher error robustness in order of bit positions [H, H, M, M, L, L]. Therefore, according to the differentiated multilevel modulation, PDU1 is mapped only to the H, H bit positions in each of the 8 modulation symbols. That is, the first pair of bits of the PDU1 are mapped to the H, H bit positions in a first symbol, the second pair of bits are mapped to the H, H bit positions in a second symbol, and the third pair of bits are mapped to the H, H bit positions in a third symbol. In the same manner, the other bits are sequentially mapped to up to an eighth symbol. Accordingly, the 16 bits of the PDU1 are mapped to the first two bit positions in each of the 8 modulation symbols, so that they can be transmitted to be optimally robust against errors.

Next, PDU2 is mapped to M, M bit positions in each of the 8 modulation symbols. That is, the first pair of bits of the PDU2 are mapped to the M, M bit positions in the first symbol, the second pair of bits are mapped to the M, M bit positions in the second symbol, and the third pair of bits are mapped to the M, M bit positions in the third symbol. In the same manner, the other bits are sequentially mapped up to the eighth symbol.

Next, PDU3 is mapped to the last two L, L bit positions in each of the 8 symbols in the same manner as for PDU1 and PDU2.

Due to the mapping, the PDU1 has the highest robustness against channel errors, and the PDU2 and the PDU3 have the next highest robustness against channel errors in sequence. That is, the PDU1 transmitted through an arbitrary channel environment has a higher reception probability than the PDU2 or the PDU3.

By designing the PDUs such that they have multilevel robustness against errors, in a poor channel environment, a transmitter modulates and encodes the PDU1 using low-order modulation (e.g., Quadrature Phase-Shift Keying (QPSK)) and a low coding rate (e.g., a coding rate ½), so that a receiver can successfully receive at least the PDU1. In addition, in a good channel environment, the transmitter modulates and encodes a plurality of PDUs using high-order modulation (e.g., 16QAM or higher-order modulation) and a high coding rate (e.g., ¾) so that the receiver can successfully receive the plurality of PDUs.

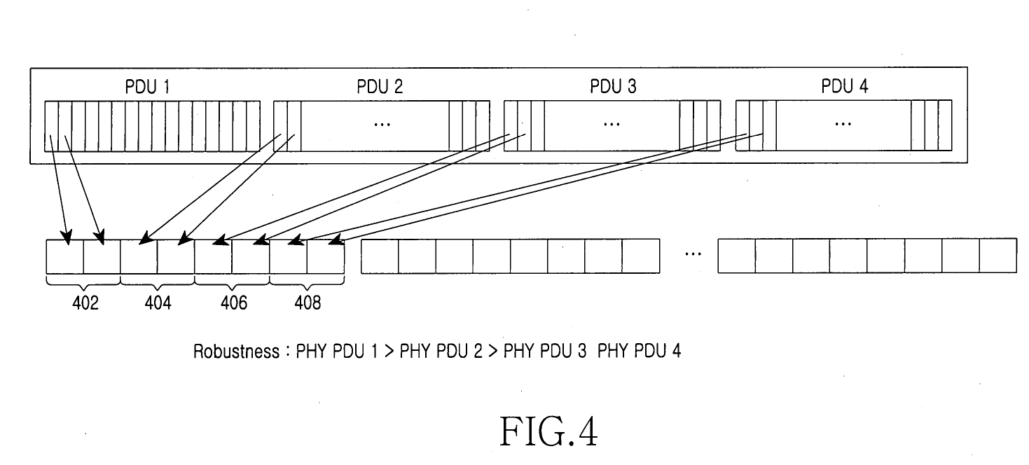

FIG. 4 is a diagram illustrating a symbol mapping process for 256QAM-modualted PDUs in a wireless mobile communication system according to the first embodiment of the present invention.

Referring to FIG. 4, each PDU is assumed to be composed of 16 bits that include CRC check bits. The use of the 256QAM can transmit modulation symbols associated with four PDUs, and one modulation symbol is composed of 8 bits. Therefore, a total of 8 modulation symbols are needed to transmit four PDUs.

The 256QAM-modualted symbol has higher error robustness in order of bit positions 402, 404, 406 and 408. Therefore, according to the differentiated multilevel modulation, PDU1 is mapped to the bit positions 402 and their corresponding bit positions in the 8 modulation symbols. That is, the first pair of bits of the PDU1 are mapped to the bit positions 402 in a first symbol, the second pair of bits are mapped to the bit positions corresponding to the bit positions 402 in a second symbol, and the third pair of bits are mapped to the bit positions corresponding to the bit positions 402 in a third symbol. Accordingly, the other bits are sequentially mapped to up to an eighth symbol. In this manner, the 16 bits of the PDU1 are mapped to the first two bit positions in each of the 8 modulation symbols, so that they can be transmitted to be most robust against errors.

Next, PDU2 is mapped to the bit positions 404 and their corresponding bit positions in the 8 modulation symbols. That is, the first pair of bits of the PDU2 are mapped to the bit positions 404 in the first symbol, the second pair of bits are mapped to the two bit positions corresponding to the bit positions 404 in the second symbol, and the third pair of bits are mapped to the two bit positions corresponding to the bit positions 404 in the third symbol. In the same manner, the other bits are sequentially mapped up to the eighth symbol.

Next, PDU3 and PDU4 are mapped to the bit positions 406 and 408 and their corresponding bit positions in the 8 modulation symbols, respectively, in the same manner as for PDU1 and PDU2.

As a result of the mapping, PDU1 has the highest robustness against channel errors, and PDU2, PDU3 and PDU4 have the next highest robustness against channel errors in sequence. That is, PDU1 transmitted through an arbitrary channel environment has a higher reception probability than PDU2, PDU3 and PDU4.

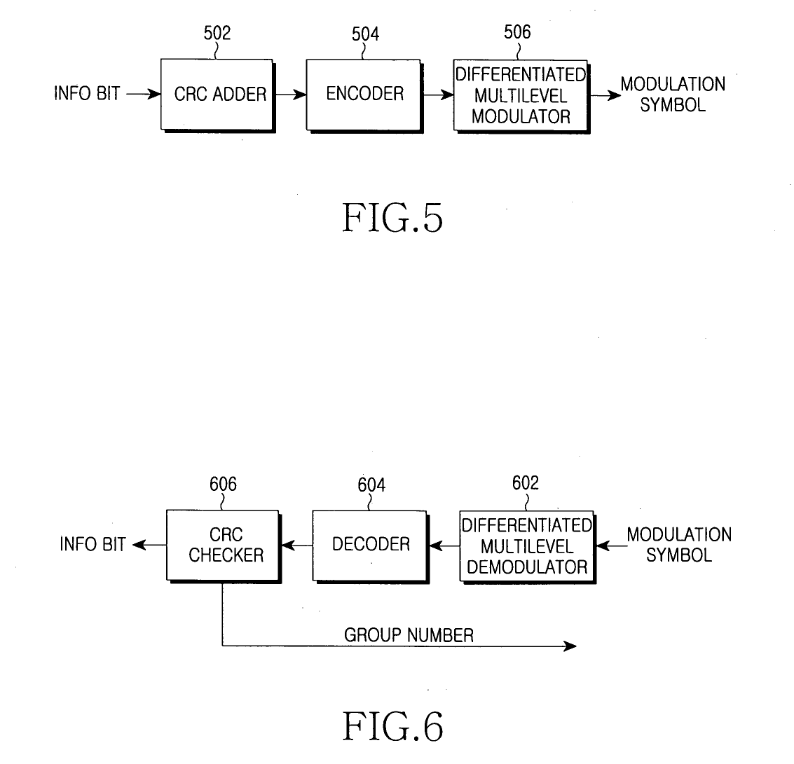

FIG. 5 is a block diagram illustrating a structure of a transmitter in a wireless mobile communication system according to the first embodiment of the present invention.

Referring to FIG. 5, the transmitter includes a cyclic redundancy check (CRC) adder 502, an encoder 504 and a differentiated multilevel modulator 506. When the transmitter transmits signals using M-QAM, the present invention can set log₂(M)/2 PDUs as one group. That is, when the 64QAM is used as shown FIG. 3, the present invention can set 3 PDUs as one group, and when the 256QAM is used as shown in FIG. 4, the present invention can set 4 PDUs as one group.

The CRC adder 502 receives transmission information bits, and adds CRC bits for error check to the received information bits. The encoder 504 receives the CRC bit-added PDU, encodes the received PDU using an encoding technique, and outputs the coded bits. Herein, the encoding technique refers to a technique used for encoding the received PDU so as to output desired transmission bits and error control bits for the transmission bits. The encoding technique includes turbo coding and convolutional coding.

The differentiated multilevel modulator 506 outputs symbols modulated by mapping the coded bits to symbols according to a modulation scheme. The process of mapping the encoded bits to the symbols has been described above with reference to FIGS. 3 and 4.

Although not illustrated in FIG. 5, the transmitter includes a controller which determines a coding rate and a modulation scheme according to wireless channel state, controls a coding rate of the encoder 504 according to the determined coding rate, and controls the differentiated multilevel modulator 506 according to the determined modulation scheme. In addition, the controller executes the command from an upper layer that has received a transmission/retransmission request from a receiver.

FIG. 6 is a block diagram illustrating a structure of a receiver in a wireless mobile communication system according to the first embodiment of the present invention.

Referring to FIG. 6, the receiver includes a differentiated multilevel demodulator 602, a decoder 604 and a CRC checker 606.

The differentiated multilevel demodulator 602 demodulates modulation symbols transmitted from the transmitter using a differentiated multilevel demodulation scheme corresponding to the differentiated multilevel modulation scheme of the transmitter.

The decoder 604 decodes the demodulated coded bits into desired information bits using a decoding scheme corresponding to the encoding scheme of the transmitter.

The CRC checker 606 receives the decoded information bits output from the decoder 604, extracts CRC bits from the received information bits on a PDU-by-PDU basis, and determines whether there is an error in a corresponding PDU using the extracted CRC bits. If it is determined that there is no error in the corresponding PDU, the PDU is temporarily stored in a buffer and then delivered to an upper layer. However, if it is determined that there is an error in the corresponding PDU, the receiver sends a signal for requesting retransmission of the PDU to the transmitter. The transmission/retransmission request signal issued by the receiver can be a group number signal according to a second embodiment of the present invention.

The error-free PDUs are removed from the buffer by the CRC checker 606, whereas the defective PDUs may remain in or be removed from the buffer. Whether the defective PDU information will remain in the buffer is determined depending on the type of a Hybrid Automatic Repeat Request (H-ARQ) technique in use.

If an error occurs in an initially transmitted data packet, then retransmission of the packet is necessary to compensate for the error. A retransmission control technique used in this case is the H-ARQ technique. H-ARQ can be classified into Chase Combining (CC), Full Incremental Redundancy (FIR) and Partial Incremental Redundancy (PIR).

CC is a scheme for simply transmitting the same full packet as the initially transmitted packet during retransmission. In this scheme, a receiver combines the retransmitted packet with the initially transmitted packet stored in a reception buffer depending on a scheme, thereby improving reliability for the coded bits input to a decoder and thus obtaining a performance gain of the entire system. Combining the same two packets is equivalent in effect to iterative decoding, obtaining a performance gain of about 3 dB on average.

FIR is a method for retransmitting a packet composed of only the redundancy bits generated in an encoder instead of the same packet as the initially transmitted packet, thereby improving a coding gain of a decoder in a receiver. That is, the decoder performs decoding using not only the information received during initial transmission but also the new redundancy bits, resulting in an increase in the coding gain. The increase in the coding gain contributes to an increase in the decoding performance.

PIR is a method for transmitting a data packet composed of a combination of information bits and new redundancy bits during retransmission. During decoding, PIR combines the information bits with the initially transmitted information bits, thereby obtaining a similar effect to that of CC. In addition, PIR performs decoding using the redundancy bits, thereby obtaining a similar effect to that of FIR as well. PIR, as it is slightly higher in coding rate than FIR, generally shows the performance intermediate between the FIR performance and the CC performance.

A description will now be made of a scheme in which in a wireless mobile communication system according to a second embodiment of the present invention, a receiver recognizes normally/abnormally received PDUs, and notifies an appropriate indicator value, i.e. a group number, to a transmitter, to thereby receive or re-receive the PDUs with minimal signaling load.

The group number indicates index information for an MCS level, and a transceiver can use the group number to find the number of PDUs included one group and a modulation scheme for the PDUs. For example, if a transmitter sets the group number to ‘1’ and sends the group number ‘1’ to a receiver, the receiver can know that one PDU is PQSK-modulated before being transmitted. Similarly, a group number ‘2’ indicates that two PDUs are 16QAM-modulated, a group number ‘3’ indicates that three PDUs are 64QAM-modulated, and a group number ‘4’ indicates that four PDUs are 256QAM-modulated.

The group number transmitted by the receiver to the transmitter serves to indicate the number of normally received PDUs. For example, the transmitter transmits three PDUs associated with the group number ‘3’ using 64QAM, and if the receiver normally receives all of the three PDUs, it feeds back the group number ‘3’ to the transmitter. If the receiver normally receives two PDUs, it feeds back the group number ‘2’ to the transmitter. If the receiver normally receives one PDU, it feeds back the group number ‘1’ to the transmitter. If the receiver fails to receive all PDUs, it can feed back a group number ‘0’ to the transmitter. The transmitter retransmits the PDUs associated with the group number transmitted by the transmitter.

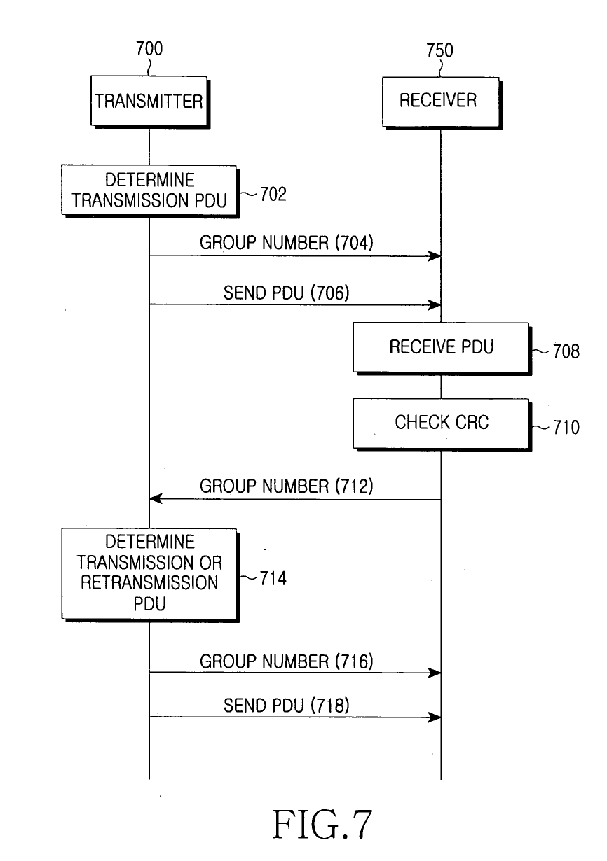

FIG. 7 is a signaling diagram illustrating a signal flow for PDU transmission/reception in a wireless mobile communication system according to the second embodiment of the present invention.

Referring to FIG. 7, a transmitter 700 determines the number of PDUs to be transmitted to a receiver 750 in step 702, and transmits a group number associated with the determined number of PDUs to the receiver 750 over a control channel in step 704. Thereafter, the transmitter 700 transmits the corresponding PDUs to the receiver 750 in step 706. Herein, the PDUs are the data modulated by the differentiated multilevel modulation according to the first embodiment of the present invention.

The receiver 750 receives the PDUs in step 708, and performs CRC check on the received PDUs in step 710. The receiver 750 recognizes normally received PDUs and abnormally received PDUs depending on the CRC check results, and transmits a group number associated with the number of the normally received PDUs to the transmitter 700 in step 712.

The transmitter 700 determines the PDUs that it will transmit or retransmit next, according to the received group number, in step 714. If the transmitter 700 determines to retransmit the PDUs, the transmitter 700 may use a modulation scheme which is lower by one level than the modulation scheme used for previous transmission in terms of the order, or may use a modulation scheme associated with the group number transmitted by the receiver 750. That is, the transmitter 700 transmits four PDUs using 256QAM, and if a group number transmitted by the receiver 750 is ‘1’, it may transmit a total of four PDUs up to a new PDU6, including retransmitting three defective PDUs of PDU2, PDU3 and PDU4 using 256QAM used by the transmitter 700, during the next PDU retransmission, and may retransmit the PDU2, a selected one of the three defective PDUs, using QPSK associated with the group number ‘1’.

The transmitter 700 transmits the group number associated with the determined number of PDUs to the receiver 750 in step 716, and transmits or retransmits the corresponding PDUs to the receiver 750 in step 718.

As described above, the present invention uses only the group numbers between the transmitter and the receiver, thereby minimizing the signaling load and complexity compared with the method of notifying an index of the failed PDU.

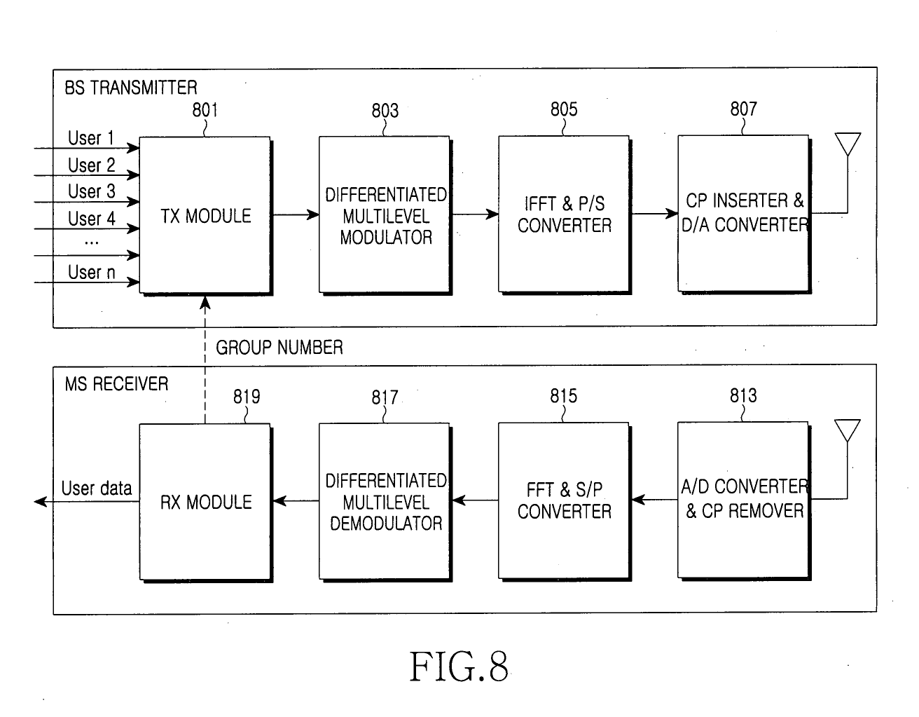

FIG. 8 is a block diagram illustrating a structure of a downlink transceiver in a wireless mobile communication system using an Orthogonal Frequency Division Multiple Access (OFDMA) scheme (hereinafter OFDMA wireless mobile communication system) according to the second embodiment of the present invention.

Referring to FIG. 8, a downlink transmitter is a BS transmitter and a downlink receiver is an MS receiver. The BS transmitter includes a transmission module 801, a differentiated multilevel modulator 803, an Inverse Fast Fourier Transform & Parallel-to-Serial Converter (IFFT & P/S converter) 805, and a Cyclic Prefix inserter and Digital-to-Analog converter (CP inserter & D/A converter) 807. The transmission module 801 includes the CRC adder 502 and the encoder 504 of FIG. 5.

The MS receiver includes an Analog-to-Digital converter and CP remover (A/D converter & CP remover) 813, a Fast Fourier Transform & Serial-to-Parallel Converter (FFT & P/S converter) 815, a differentiated multilevel demodulator 817 and a reception module 819. The reception module 819 includes the CRC checker 606 and the decoder 604 of FIG. 6.

The BS transmitter has data, i.e. PDUs, to be individually transmitted to a plurality of MSs. The transmission module 801 adds a CRC to the PDUs for the individual MSs, encodes the CRC-added PDUs and outputs the coded PDUs to the differentiated multilevel modulator 803. The differentiated multilevel modulator 803 performs differentiated multilevel modulation corresponding to the determined modulation scheme on the PDUs, and outputs modulation symbols to the IFFT & P/S converter 805. The IFFT & P/S converter 805 performs IFFT on the modulation symbols, converts the parallel IFFT-processed signal into a serial signal, and outputs the serial signal to the CP inserter & D/A converter 807. The CP inserter & D/A converter 807 inserts a CP into the input signal, converts the CP-inserted digital signal into an analog signal and transmits the analog signal via an antenna. The transmission module 801 determines transmission/retransmission PDUs according to a group number received from the MS receiver.

The A/D converter & CP remover 813 in the MS receiver receives the signal transmitted from the BS transmitter, removes a CP from the received signal, converts the CP-removed analog signal into a digital signal, and outputs the digital signal to the FFT & P/S converter 815. The FFT & P/S converter 815 performs FFT on the input signal, converts the FFT-processed serial signal into a parallel signal and outputs the parallel signal to the differentiated multilevel demodulator 817. The differentiated multilevel demodulator 817 demodulates modulation symbols in units of subchannels allocated to each individual MS, and outputs demodulated PDUs to the reception module 819. The reception module 819 performs decoding and CRC check on the input signal, and determines normally received PDUs. The reception module 819 transmits a group number associated with the normally received PDUs to the BS transmitter, thereby requesting transmission of new PDUs or requesting retransmission of the abnormally received PDUs.

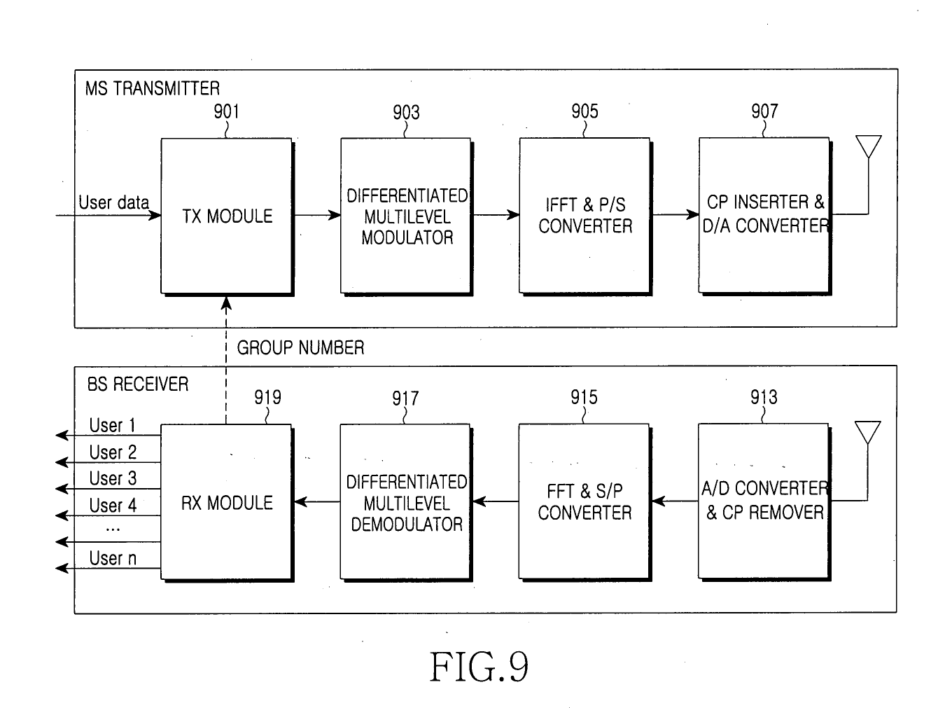

FIG. 9 is a block diagram illustrating a structure of an uplink transceiver in an OFDMA wireless mobile communication system according to the second embodiment of the present invention.

Referring to FIG. 9, an uplink transmitter is an MS transmitter and an uplink receiver is a BS receiver. The MS transmitter includes a transmission module 901, a differentiated multilevel modulator 903, an IFFT & P/S converter 905 and a CP inserter & D/A converter 907.

The BS receiver includes an A/D converter & CP remover 913, an FFT & P/S converter 915, a differentiated multilevel demodulator 917 and a reception module 919.

The MS transmitter and the BS receiver are equal in operation to the BS transmitter and the MS receiver of FIG. 8 except for the operation subjects, so a detailed description thereof will be omitted.

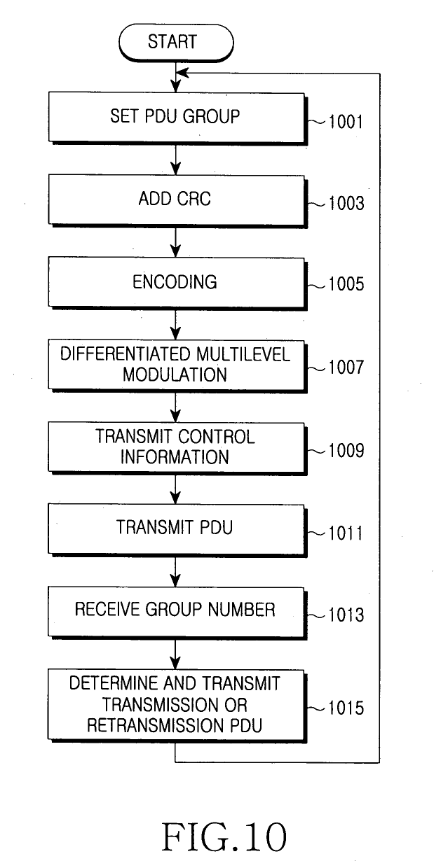

FIG. 10 is a flowchart illustrating a signal transmission process of a BS transmitter in a wireless mobile communication system according to the second embodiment of the present invention.

Referring to FIG. 10, in step 1001, the transmitter sets a number of PDUs as one group according to differentiated multilevel modulation. Herein, the PDUs may be the initially transmitted PDUs, or the PDUs retransmitted in response to a request from an MS receiver. In step 1003, the transmitter adds CRC bits for error check to the PDUs set as one group. In step 1005, the transmitter encodes the PDUs according to a coding scheme adaptively determined according to the channel state. In step 1007, the transmitter performs modulation on the coded PDUs according to the differentiated multilevel modulation. In an OFDM/OFDMA wireless mobile communication system, an IFFT calculation process, a P/S conversion process, a CP insertion process and a D/A conversion process can be added after step 1007.

In step 1009, the transmitter transmits control information to the receiver. The control information includes group number information indicating the number of transmission PDUs and MCS level information, and channel allocation information regarding a time slot and a frequency slot to which the control information is allocated. Although it is shown that the control information is transmitted after step 1007, it can be transmitted anytime before PDU transmission.

In step 1011, the transmitter transmits PDUs belonging to the set PDU group to the receiver. In step 1013, the transmitter receives a group number from the receiver. The group number transmitted by the receiver, as described above, indicates the number of PDUs that the receiver has successfully received. In step 1015, the transmitter transmits or retransmits new PDUs except for the PDUs that the receiver has normally received.

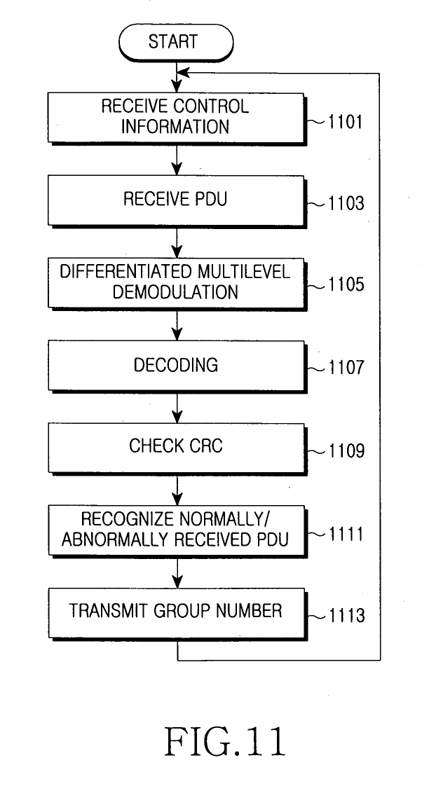

FIG. 11 is a flowchart illustrating a signal reception process of an MS receiver in a wireless mobile communication system according to the second embodiment of the present invention.

Referring to FIG. 11, in step 1101, the receiver receives control information including a group number from a BS transmitter. In step 1103, the receiver receives PDUs, i.e. modulation symbols, transmitted from the BS transmitter. In step 1105, the receiver demodulates the modulation symbols using a demodulation scheme corresponding to the modulation scheme of the transmitter. In step 1107, the receiver decodes the demodulated symbols using a decoding scheme corresponding to the coding scheme of the transmitter. In step 1109, the receiver performs CRC check on the decoded PDUs. In step 1111, the receiver recognizes normally/abnormally received PDUs depending on the CRC check results. In step 1113, the receiver can request retransmission of the abnormally received PDUs, or request transmission of new PDUs after it has normally received all PDUs. Therefore, the receiver transmits to the BS transmitter the group number associated with the number of PDUs that it desires to receive or re-receive.

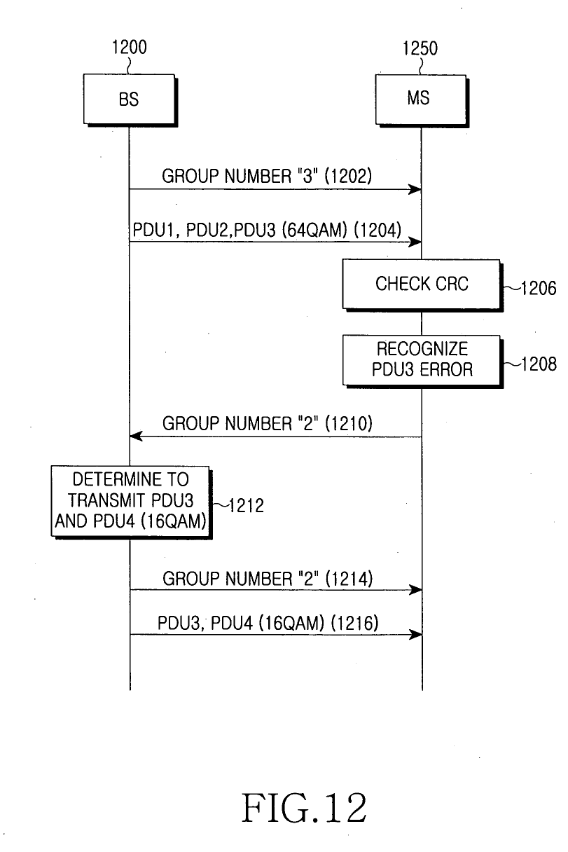

FIG. 12 is a signaling diagram illustrating a signal transmission/reception process between a BS and an MS in a wireless mobile communication system according to the second embodiment of the present invention.

Referring to FIG. 12, in step 1202, a BS 1200 transmits to an MS 1250 a group number ‘3’ indicating that it has 3 transmission PDUs and transmits the PDUs using 16QAM as a modulation scheme. After transmitting the group number, the BS 1200 transmits modulation symbols obtained by modulating corresponding PDUs, i.e. PDU1, PDU2 and PDU3, using 64QAM to the MS 1250 in step 1204.

After receiving the modulation symbols, the MS 1250 performs demodulation and decoding on the received modulation symbols, and performs CRC check on the corresponding PDUs in step 1206. In step 1208, the MS 1250 recognizes that the PDU3 was abnormally received, depending on the CRC check results. Therefore, in step 1210, the MS 1250 transmits a group number ‘2’ to the BS 1200 for re-reception of the PDU3.

If the BS 1200 receives the group number ‘2’ from the MS 1250, it recognizes that the MS 1250 has normally received PDU1 and PDU2. Therefore, in step 1212, the BS 1200 determines retransmission of the PDU3 and transmission of PDU4, and determines to use 16QAM for transmission of the PDUs. In step 1214, the BS 1200 transmits to the MS 1250 a group number ‘2’ indicating transmission of the PDU3 and PDU4 with 16QAM. Thereafter, in step 1216, the BS 1200 transmits the PDU3 and PDU4 to the MS 1250.

As can be understood from the foregoing description, in the fast varying channel environment, the present invention obtains almost the same effect as that of the AMC scheme with a signaling load less than that of the AMC scheme. That is, the wireless mobile communication system transmits data at high robustness against channel errors using the differentiated multilevel modulation scheme, so the receiver transmits an appropriate indicator value, i.e. group number, to the transmitter, thereby reducing the signaling load. In addition, even when requesting signal retransmission, the present invention can reduce an overhead compared with the conventional method, thereby improving the system performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting a signal in a communication system that encodes desired transmission packet data units (PDUs), the method comprising the steps of:
dispersedly mapping the coded bits to each of a plurality of modulation symbols determined according to a modulation scheme; and
transmitting the modulation symbols.

2. The method of claim 1, wherein the coded bits are mapped to bit positions having a particular reliability in each of the modulation symbols.

3. A method for transmitting a packet data unit (PDU) by a transmitter in a wireless mobile communication system, the method comprising the steps of:
determining at least one desired transmission PDU;
determining a modulation scheme, and transmitting a first indicator value indicating the number of the determined PDUs and the modulation scheme;
transmitting the PDUs;
receiving a second indicator value indicating a reception state of the PDUs, from a receiver that receives the PDUs;
determining a new PDU or a retransmission PDU according to the second indicator value; and
determining a modulation scheme corresponding to the number of the determined PDUs, and transmitting a third indicator value indicating the number of PDUs, the modulation scheme and the corresponding PDUs.

4. The method of claim 3, wherein the PDUs that the receiver receives are encoded at a coding rate, and are modulation symbols obtained by modulating the coded bits, and bits of different individual PDUs are dispersedly mapped to bit positions having different reliabilities in the modulation symbols.

5. The method of claim 4, wherein the transmitter retransmits the PDU using a modulation scheme having an order lower than that of a previously used modulation scheme if the second indicator value is for requesting retransmission of at least one PDU among the PDUs transmitted by the transmitter.

6. The method of claim 4, wherein the transmitter retransmits the PDU using a modulation scheme corresponding to the second indicator value, if the second indicator value is for requesting retransmission of a specific PDU.

7. The method of claim 4, wherein the indicator values are selected such that they are mapped to different Modulation and Coding Scheme (MCS) levels.

8. A method for receiving a packet data unit (PDU) by a receiver in a wireless mobile communication system, the method comprising the steps of:
receiving a first indicator value indicating an amount of PDUs and a modulation scheme, from a transmitter;
receiving at least one PDU, and performing error check on the received PDU; and
transmitting to the transmitter a second indicator value indicating normal/abnormal receipt of the PDU.

9. The method of claim 8, wherein the PDUs that the receiver has received are encoded at a coding rate, and are modulation symbols obtained by modulating the coded bits, and bits of different individual PDUs are dispersedly mapped to bit positions having different reliabilities in the modulation symbols.

10. An apparatus for transmitting a signal in a wireless mobile communication system including an encoder for encoding desired transmission packet data units (PDUs) and outputting the coded bits, the apparatus comprising:
a differentiated multilevel modulator for dispersedly mapping the coded bits to each of a plurality of modulation symbols determined according to a modulation scheme, and transmitting the modulation symbols.

11. The apparatus of claim 10, wherein the differentiated multilevel modulator maps the coded bits to bit positions having a particular reliability in each of the modulation symbols.

12. An apparatus for receiving a signal in a wireless mobile communication system including a decoder for decoding input coded bits, the apparatus comprising:
a differentiated multilevel demodulator for receiving modulation symbols, demodulating the modulation symbols using a demodulation scheme corresponding to a modulation scheme, and outputting the coded bits, wherein the coded bits are dispersedly mapped to each of a number of modulation symbols determined according to the modulation scheme

13. The apparatus of claim 12, wherein the coded bits are mapped to bit positions having a particular reliability in each of the modulation symbols.
